(19) United States
(12) Patent Application Publication
(10) Pub. No.: US 2026/0370588 A1
(43) Pub. Date: Nov. 19, 2026

(54) Cloud Resource Monitoring and Management Across Multiple Environments

(71) Applicant: DISH Wireless L.L.C., Littleton, CO (US)

(72) Inventors: Devin Drawhorn, Spring, TX (US); Steven Wilson, Aurora, CO (US); Kevin Plunkett, Aurora, CO (US)

(21) Appl. No.: 19/208,188

(22) Filed: May 14, 2025

(51) Int. Cl. H04L 43/55; H04L 43/20

(52) U.S. Cl. CPC H04L 43/55; H04L 43/20

(57) ABSTRACT

Various embodiments are directed to managing cellular network resources on a cloud computing platform by defining a set of monitoring policies within a storage container, creating an event schedule to determine execution times for these policies, and using a cloud resource management tool to execute various functions based on the schedule. The arrangements perform tasks such as resource allocation and monitoring, and logs the results of these activities on the cloud platform. By centralizing policy definition, scheduling, execution, and logging, the arrangements detailed herein enhance the efficiency, automation, and scalability of cellular network resource management.

### BACKGROUND

The monitoring and management of software components being executed on a cloud computing platform can be time-consuming and difficult. Further, software components can be deployed across multiple cloud computing platform environments that are associated with separate cloud computing platform accounts, adding to the difficultly of monitoring components.

Specifically, a cellular network can have a significant portion of its functions deployed on a cloud computing platform. Various network functions (NFs) may need to be created, monitored, modified, and deleted over time. Manually monitoring the various NFs and components of the cellular network on a cloud computing platform across multiple environments can be difficult to manage. Embodiments detailed herein address these and additional problems.

### SUMMARY

A method for performing cellular network cloud resource management can include defining, on a cloud computing platform, a plurality of cellular network monitoring policies within a storage container. The method may further comprise creating, on the cloud computing platform, an event schedule that defines an execution time for each cellular network monitoring policy to be executed on the cloud computing platform. Based on the event schedule, the method can include executing, on the cloud computing platform, a cloud resource management tool to perform a plurality of functions defined by a cellular network monitoring policy of the plurality of cellular network monitoring policies. The method may further include logging, by the cloud resource management tool on the cloud computing platform, a plurality of results of executing the cloud resource management tool performing the plurality of functions defined by the cellular network monitoring policy.

Embodiments of such a method can include one or more of the following features. Any of these features can be implemented distinct from other features provided below. Executing the cloud resource management tool to perform the plurality of functions defined by the cellular network monitoring policy may comprise filtering, by the cloud resource management tool, a plurality of instances of cellular network functions (NFs) executed on the cloud computing platform. The filtering can identify one or more instances of cellular NFs that meet a set of parameters of the cellular network monitoring policy. The method may further include performing, by the cloud resource management tool, an action on each of the one or more identified instances of cellular NFs that meet the set of parameters of the cellular network monitoring policy. The one or more identified instances of cellular NFs may be 5G New Radio (NR) core NFs. The action performed on each of the one or more identified instances of cellular NFs can comprise tagging the identified instances for deletion. The cloud computing platform may be a public cloud computing platform. The cloud resource management tool can perform the plurality of functions defined by the cellular network monitoring policy of the plurality of cellular network monitoring policies within a cloud environment accessible via the cloud computing platform account. The method may further comprise accessing, by the cloud resource management tool, a second set of cloud computing platform account credentials mapped to a second cloud computing platform account. The method can include executing, on the cloud computing platform, the cloud resource management tool to perform the plurality of functions defined by the cellular network monitoring policy of the plurality of cellular network monitoring policies within a second cloud environment accessible via the second cloud computing platform account. The method may further include logging, by the cloud resource management tool, a second plurality of results of executing the cloud resource management tool performing the plurality of functions defined by the cellular network monitoring policy to a report datastore. Executing the cloud resource management tool to perform the plurality of functions defined by the cellular network monitoring policy may comprise deploying, by the cloud resource management tool, a function on the cloud computing platform. The function can monitor application programming interface (API) events. The method may further comprise publishing, by the function on the cloud computing platform that monitors API events, event information based on a monitored API event. The method can further include obtaining, by a second function executed on the cloud computing platform, the event information based on the second function having been subscribed to a type of event corresponding to the monitored API event. The method may further comprise causing, by the second function executed on the cloud computing platform, a notification to be transmitted to one or more user accounts that are subscribed to the type of event. The notification can be based on the obtained event information.

In some embodiments, a cloud resource monitoring and management system is present which can comprise a cloud computing environment defined on a cloud computing platform. The system may include a plurality of cellular network monitoring policies within a storage container in the cloud computing environment. The system can further comprise an event schedule that defines an execution time for each cellular network monitoring policy to be executed in the cloud computing environment on the cloud computing platform. The system may include a cloud resource management tool within the cloud computing environment. The cloud resource management tool can be configured to perform a plurality of functions defined by a cellular network monitoring policy of the plurality of cellular network monitoring policies based on the event schedule. The cloud resource management tool may further be configured to log a plurality of results of executing the plurality of functions defined by the cellular network monitoring policy.

Embodiments of such a system can include one or more of the following features. Any of these features can be implemented distinct from other features provided below. The cloud resource management tool may be further configured to filter a plurality of instances of cellular network functions (NFs) executed on the cloud computing platform. The filtering can identify one or more instances of cellular NFs that meet a set of parameters of the cellular network monitoring policy. The cloud resource management tool may further be configured to perform an action on each of the one or more identified instances of cellular NFs that meet the set of parameters of the cellular network monitoring policy. The one or more identified instances of cellular NFs may be 5G New Radio (NR) core NFs. The action performed on the one or more identified instances of cellular NFs may comprise tagging the identified instances for deletion. The cloud resource management tool may further be configured to access the cloud computing platform account credentials mapped to a cloud computing platform account. The cloud computing platform may be a public cloud computing platform. The cloud resource management tool may further be configured to execute to perform the plurality of functions defined by the cellular network monitoring policy of the plurality of cellular network monitoring policies within a second cloud environment accessible via the second cloud computing platform account. The cloud resource management tool can log a second plurality of results of executing the cloud resource management tool to a report datastore. The cloud resource management tool may further be configured to deploy a function within the cloud computing environment on the cloud computing platform. The function can monitor application programming interface (API) events. The function on the cloud computing platform that monitors API events may be configured to publish event information based on a monitored API event. The system can further comprise a second function executed in the cloud computing environment on the cloud computing platform. The second function may be configured to obtain event information from the function for a type of event corresponding to the monitored API event. The second function may further be configured to cause a notification to be transmitted to one or more user accounts that are subscribed to the type of event. The notification can be based on the obtained event information.

In some embodiments, a non-transitory processor-readable medium is present. The processor-readable instructions may be configured to cause one or more processors to define a plurality of cellular network monitoring policies within a storage container in a cloud computing environment on a cloud computing platform. The processor-readable instructions can further cause one or more processors to create an event schedule that defines an execution time for each cellular network monitoring policy to be executed in the cloud computing environment on the cloud computing platform. Based on the event schedule, the processor-readable instructions may further cause one or more processors to perform a plurality of functions defined by a cellular network monitoring policy of the plurality of cellular network monitoring policies in the cloud computing environment on the cloud computing platform. The processor-readable instructions can further cause one or more processors to log a plurality of results of executing the plurality of functions defined by the cellular network monitoring policy within the cloud computing environment and external to the cloud computing environment.

### BRIEF DESCRIPTION OF THE DRAWINGS

A further understanding of the nature and advantages of various embodiments may be realized by reference to the following figures. In the appended figures, similar components or features may have the same reference label. Further, various components of the same type may be distinguished by following the reference label by a dash and a second label that distinguishes among the similar components. If only the first reference label is used in the specification, the description is applicable to any one of the similar components having the same first reference label, irrespective of the second reference label.

FIG. 1 illustrates an embodiment of a cellular network system, according to certain embodiments.

FIG. 2 illustrates an exemplary core, according to certain embodiments.

FIG. 3 illustrates an embodiment of a cellular network core network topology as implemented on a public cloud computing platform, according to certain embodiments.

FIG. 4 illustrates an embodiment of a cloud resource monitoring and management system.

FIG. 5 illustrates an embodiment of a method for performing cloud resource management.

FIG. 6 illustrates another embodiment of a method for performing cloud resource management.

FIG. 7 illustrates an embodiment of a system for deploying the cloud resource monitoring and management system to additional environments.

FIG. 8 illustrates an embodiment of a method for deploying the cloud resource monitoring and management system to additional environments.

### DETAILED DESCRIPTION

In order to perform monitoring and management in a cloud computing environment, a cloud resource management tool can be deployed that is configured to enforce various policies according to set event rules according to various embodiments detailed herein. Such an implementation allows for numerous policies to be enforced across one or more cloud computing environments.

The cloud resource management tool can be employed in such a manner in complex cloud environments, such as a cellular network that has NFs implemented on a public cloud computing platform. The policies can be used to instantiate, modify, monitor, and delete cellular NFs, such as core NFs of a 5G NR cellular network. Additionally, or alternatively, the embodiments detailed herein can be applied to non-cellular network embodiments for other uses of cloud computing.

In some embodiments, a first function can be deployed in the cloud computing environment that allows for the monitoring of application programming interface (API) events. An additional function may monitor for a particular type of API event captured by the first function. Users can subscribe to one or more types of API events and receive a notification with information about related API events from the second function.

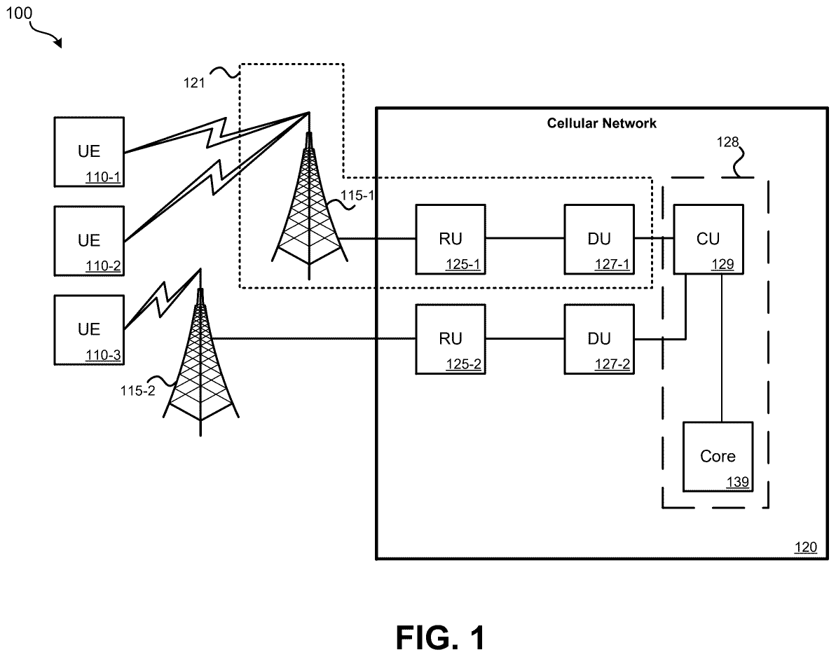

Further detail regarding these and additional embodiments is provided in relation to the figures. FIG. 1 illustrates an embodiment of a cellular network, including radio access network (RAN) components, referred to as cellular network system 100 (“system 100”). System 100 can include a fifth generation (5G) New Radio (NR) cellular network; other types of cellular networks, such as fourth generation (4G) long-term evolution (LTE) cellular network, sixth generation (6G) cellular network, seventh generation (7G) cellular network, and beyond are also possible to use in accordance with embodiments detailed herein. System 100 can include: UE 110 (UE 110-1, UE 110-2, UE 110-3); base station 115; cellular network 120; radio units 125 (“RUs 125”); distributed units 127 (“DUs 127”); centralized unit 129 (“CU 129”); and core 139.

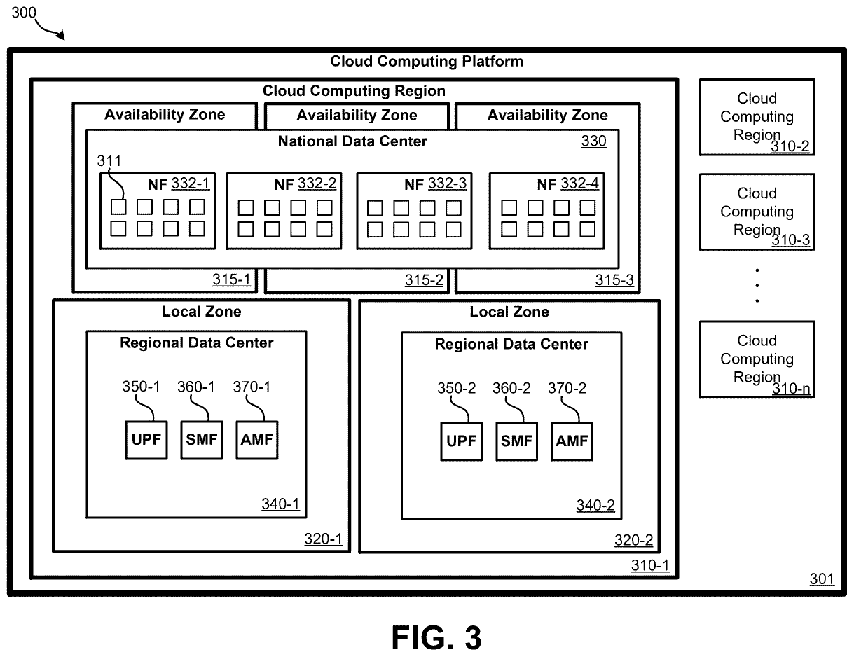

FIG. 1 represents a component-level view. In a virtualized open radio access network (O-RAN), because components can be implemented as software in the cloud, except for components that receive and transmit RF, the functionality of various components can be shifted among different servers, for which the hardware may be maintained by a separate (e.g., public) cloud service provider, to accommodate where the functionality of such components is needed, such as detailed in relation to FIG. 3. As an example, a public cloud computing provider, such as Amazon Web Services (AWS), can be used to host cellular network functions in association with an account mapped to the cellular network provider. While other accounts are present and having software executed by the public cloud computing provider, cellular network functions are isolated from such other components and behave as if present on a private cloud platform.

UEs 110 can represent various types of end-user devices, such as smartphones, cellular modems, cellular-enabled computerized devices, sensor devices, manufacturing equipment, gaming devices, access points (APs), any computerized device capable of communicating via a cellular network, etc. UEs can also represent any type of device that has incorporated a cellular (e.g., 5G) interface, such as a 5G modem. Examples include sensor devices, Internet of Things (IoT) devices, manufacturing robots, unmanned aerial (or land-based) vehicles, network-connected vehicles, environmental sensors, etc. UEs 110 use RF to communicate with RUs 125 of cellular network 120.

Two base stations 115 (BS 115-1, 115-2) are illustrated. Real-world implementations of system 100 can include many (e.g., hundreds, thousands) base stations and many RUs, DUs, and CUs. BSs 115 can include one or more antennas that allow RUs 125 to communicate wirelessly with UEs 110. RUs 125 can represent an edge of cellular network 120 where data is transitioned to wireless communication and can be located at BSs 115. In some implementations, the radio access technology (RAT) used by RU 125 is 5G New Radio (NR). Other implementations use other RAT, such as 4G Long Term Evolution (LTE) or a later radio technology related to 6G or beyond. The remainder of cellular network 120 may be based on an exclusive 5G architecture, a hybrid 4G/5G architecture, a 4G architecture, or some other cellular network architecture (e.g., 6G or beyond).

Base station equipment 121 may include at least one RU, such as RU 125-1, and a DU (e.g., DU 127-1) located on site at the base station. In some embodiments, the DU may be physically remote from the RU. In some embodiments, multiple DUs are housed at a central location and connected to geographically distant (e.g., within a couple of kilometers) RUs.

One or more RUs, such as RU 125-1, may communicate with DU 127-1. As an example, at a possible cell site, three RUs may be present, each connected with the same DU. Different RUs may be present for different portions of the spectrum. For instance, a first RU may operate on the spectrum in the citizens broadcast radio service (CBRS) band, while a second RU may operate on a separate portion of the spectrum, such as, for example, “band 71” (a radio frequency band near 600 Megahertz allocated for cellular communications).

One or more DUs, such as DU 127-1, may communicate with CU 129. Collectively, RUs, DUs, and a CU create a gNodeB, which serves as a portion of the radio access network (RAN) of cellular network 120. CU 129 can communicate with cellular network core 139 (“core 139”). The specific architecture of cellular network 120 can vary by embodiment. Edge cloud server systems (not illustrated) outside of cellular network 120 may communicate, either directly, via the Internet, or via some other network, with components of cellular network 120. For example, one or more DUs 127-1 may be able to communicate with an edge cloud server system without routing data through CU 129 or core 139.

At a high level, the various components of a gNodeB can be understood as follows: RUs perform RF-based communication with UE; DUs support lower layers of the protocol stack, such as the radio link control (RLC) layer, the medium access control (MAC) layer, and the physical communication layer; and CUs support higher layers of the protocol stack such as the service data adaptation protocol (SDAP) layer, the packet data convergence protocol (PDCP) layer, and the radio resource control (RRC) layer. A single CU can provide service to multiple co-located or geographically distributed DUs.

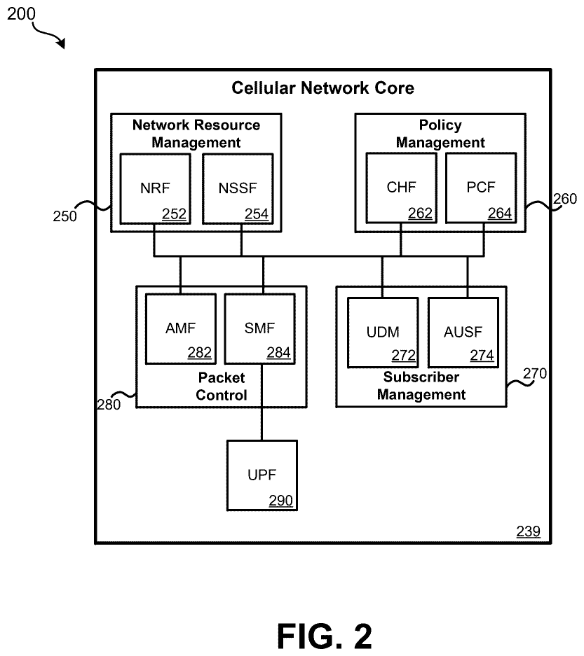

FIG. 2 illustrates core 239, according to certain embodiments. Core 239 can be physically distributed across data centers or located at a central national data center (NDC), such as detailed in relation to FIG. 3, can perform various core functions of the cellular network. Core 239 can include: network resource management components 250; policy management components 260; subscriber management components 270; and packet control components 280. Individual components may communicate via a bus, thus allowing various components of core 239 to communicate with each other directly. Core 239 is simplified to show some key components. Implementations can involve additional components.

Network resource management components 250 can include: Network Repository Function (NRF) 252 and Network Slice Selection Function (NSSF) 254. NRF 252 can allow 5G network functions (NFs) to register and discover each other via a standards-based application programming interface (API). NSSF 254 can be used by AMF 282 to assist with the selection of a network slice that will serve a particular UE (e.g., UEs 210 of FIG. 2).

Policy management components 260 can include: Charging Function (CHF) 262 and Policy Control Function (PCF) 264. CHF 262 allows charging services to be offered to authorized network functions. Converged online and offline charging can be supported. PCF 264 allows for policy control functions and the related 5G signaling interfaces to be supported.

Subscriber management components 270 can include: Unified Data Management (UDM) 272 and Authentication Server Function (AUSF) 274. UDM 272 can allow for generation of authentication vectors, user identification handling, NF registration management, and retrieval of UE individual subscription data for slice selection. AUSF 274 performs authentication with UEs.

Packet control components 280 can include: Access and Mobility Management Function (AMF) 282 and Session Management Function (SMF) 284. AMF 282 can receive connection-and session-related information from UEs and is responsible for handling connection and mobility management tasks. SMF 284 is responsible for interacting with the decoupled data plane, creating, updating, and removing Protocol Data Unit (PDU) sessions, and managing session context with the User Plane Function (UPF).

User plane function (UPF) 290 can be responsible for packet routing and forwarding, packet inspection, quality of service (QoS) handling, and external PDU sessions for interconnecting with a Data Network (DN) (e.g., the Internet).

While FIG. 1 illustrates various components of cellular network 120, it should be understood that other embodiments of cellular network 120 can vary the arrangement, communication paths, and specific components of cellular network 120. While RU 125 may include specialized radio access componentry to enable wireless communication with UE 110, other components of cellular network 120 may be implemented using specialized hardware, specialized firmware, and/or specialized software executed on a general-purpose server system. In a virtualized arrangement, specialized software on general-purpose hardware may be used to perform the functions of components such as DU 127, CU 129, and core 139. Functionality of such components can be co-located or located at disparate physical server systems. For example, certain components of core 139 may be co-located with components of CU 129.

Returning to FIG. 1, some O-RAN implementations of CU 129 and/or core 139 are implemented virtually as software being executed by general-purpose computing equipment, such as in a data center. Therefore, depending on needs, the functionality of a DU, CU, and/or 5G core may be implemented locally to each other and/or specific functions of any given component can be performed by physically separated server systems (e.g., at different server farms). For example, some functions of a CU may be located at the same server facility where the DU is executed, while other functions are executed at a separate server system. In the illustrated embodiment of system 100, cloud-based cellular network components 128 include CU 129 and core 139. In some embodiments, DUs 127 may be partially or fully added to cloud-based cellular network components 128. Such cloud-based cellular network components 128 may be specialized software executed by underlying general-purpose computer servers. Cloud-based cellular network components 128 may be executed on a public third-party cloud-based computing platform or a cloud-based computing platform operated by the same entity that operates the RAN. A cloud-based computing platform may have the ability to devote additional hardware resources to cloud-based cellular network components 128 or implement additional instances of such components when requested. A “public” cloud-based computing platform refers to a platform where various unrelated entities can each establish one or more accounts and separately utilize the cloud computing resources, the cloud computing platform managing segregation and privacy of each entity's data.

Kubernetes, or some other container orchestration platform, can be used to create and destroy the logical DU, CU, or 5G core units and subunits, as needed, for the cellular network 120 to function properly. Kubernetes allows for container deployment, scaling, and management. As an example, if cellular traffic increases substantially in a region, an additional logical DU or components of a DU may be deployed in a data center near where the traffic is occurring without any new hardware being deployed; rather, processing and storage capabilities of the data center would be devoted to the needed functions. When the need for the logical DU or subcomponents of the DU no longer exists (i.e., when traffic subsequently decreases), Kubernetes can allow for removal of the logical DU. Kubernetes can also be used to control the flow of data (e.g., messages) and inject a flow of data to various components. This arrangement can allow for the modification of nominal behavior of various layers.

A network slice functions as a virtual network operating on cellular network 120. Cellular network 120 is shared with some number of other network slices, such as hundreds or thousands of network slices. Communication bandwidth and computing resources of the underlying physical network can be reserved for individual network slices, thus allowing the individual network slices to reliably meet particular service level agreement (SLA) levels and parameters. By controlling the location and amount of computing and communication resources allocated to a network slice, the SLA attributes for UE on the network slice can be varied on different slices. A network slice can be configured to provide sufficient resources for a particular application to be properly executed and delivered (e.g., gaming services, video services, voice services, location services, sensor reporting services, data services, etc.). However, such allocations also account for resource limitations, such as to avoid allocation of an excess of resources to any particular UE group and/or application. Further, a cost may be attached to cellular slices: the greater the amount of resources dedicated, the greater the cost to the user, and thus, optimization between performance and cost is desirable.

Particular network slices may only be reserved in particular geographic regions. For instance, a first set of network slices may be present at RU 125-1 and DU 127-1, and a second set of network slices, which may only partially overlap or may be wholly different from the first set, may be reserved at RU 125-2 and DU 127-2.

Further, particular cellular network slices may include some number of defined layers. Each layer within a network slice may be used to define QoS parameters and other network configurations for particular types of data. For instance, high-priority data sent by a UE may be mapped to a layer having relatively higher QoS parameters and network configurations than lower-priority data sent by the UE that is mapped to a second layer having relatively less stringent QoS parameters and different network configurations.

As illustrated in FIG. 1, UE 110 may be operating on one or more production slices of cellular network 120. As detailed later in this document, a UE that functions on a particular entity's local network may be assigned to a slice particular to the entity or a slice that provides a particular QoE for tasks to be performed by the entity's UE.

Components such as DUs 127, CU 129, and core 139 may include various software components that are required to communicate with each other, handle large volumes of data traffic, and properly respond to changes in the network. In order to ensure not only the functionality and interoperability of such components, but also the ability to respond to changing network conditions and the ability to meet or perform above vendor specifications, significant testing must be performed.

FIG. 3 illustrates an embodiment of a cellular network core network topology 300 as implemented on a public cloud computing platform, according to certain embodiments. The cellular network core network topology 300 can be an implementation of core 139 of FIGS. 1 and 2. Cellular network core network topology 300 can represent how logical cellular network groups are distributed across cloud computing infrastructure of cloud computing platform 301. Cloud computing platform 301 can be logically and physically divided up into various different cloud computing regions 310. Each of cloud computing regions 310 can be isolated from other cloud computing regions to help provide fault tolerance, fail-over, load-balancing, and/or stability, and each of cloud computing regions 310 can be composed of multiple availability zones, each of which can be a separate data center located in general proximity to each other (e.g., within 600 miles). Further, each of cloud computing regions 310 may provide superior service to a particular geographic region based on physical proximity. For example, cloud computing region 310-1 may have its datacenters and hardware located in the northeast of the United States, while cloud computing region 310-2 may have its datacenters and hardware located in California. For simplicity, the details of the cellular network as executed in only cloud computing region 310-1 is illustrated. Similar components may be executed in other cloud computing regions of cloud computing regions 310 (310-2, 310-3, 310-n).

In other embodiments, cloud computing platform 301 may be a private cloud computing platform. A private cloud computing platform may be maintained by a single entity, such as the entity that operates the hybrid cellular network. Such a private cloud computing platform may be only used for the hybrid cellular network and/or for other uses by the entity that operates the hybrid cellular network (e.g., streaming content delivery).

Each of cloud computing regions 310 may include multiple availability zones 315. Each of availability zones 315 may be a discrete data center or group of data centers that allows for redundancy that allows for fail-over protection from other availability zones within the same cloud computing region. For example, if a particular data center of an availability zone experiences an outage, another data center of the availability zone or a separate availability zone within the same cloud computing region can continue functioning and providing service. A logical cellular network component, such as a national data center, can be created in one or across multiple availability zones 315. For example, a database that is maintained as part of NDC 330 may be replicated across availability zones 315; therefore, if an availability zone of the cloud computing region is unavailable, a copy of the database remains up-to-date and available, thus allowing for continuous or near continuous functionality.

On a (e.g., public) cloud computing platform, cloud computing region 310-1 may include the ability to use a different type of data center or group of data centers, which can be referred to as local zones 320. For instance, a client, such as a provider of the hybrid cloud cellular network, can select from more options of the computing resources that can be reserved at an availability zone 315 compared to a local zone 320. However, a local zone 320 may provide computing resources near geographic locations where an availability zone 315 is not available. Therefore, to provide low latency, certain network components, such as regional data centers 340, can be implemented at local zones 320 rather than availability zones 315. In some circumstances, a geographic region can have both a local zone 320 and an availability zone 315.

In the topology of a 5G NR cellular network, 5G core functions of core 139 can logically reside as part of a national data center (NDC) 330. NDC 330 can be understood as having its functionality existing in cloud computing region 310-1 across multiple availability zones 315. At NDC 330, various network functions, such as NFs 332, are executed. For illustrative purposes, each NF 332, whether at NDC 330 or elsewhere located, can be comprised of multiple sub-components, referred to as pods (e.g., pod 311) that are each executed as a separate process by the cloud computing region 310. The illustrated number of pods 311 is merely an example; fewer or greater numbers of pods 311 may be part of the respective 5G core functions. It should be understood that in a real-world implementation, a cellular network core, whether for 5G or some other standard, can include many more network functions. By distributing NFs 332 across availability zones 315, load-balancing, redundancy, and fail-over can be achieved. In local zones 320, multiple regional data centers 340 can be logically present. Each of regional data centers 340 may execute 5G core functions for a different geographic region or group of RAN components. As an example, 5G core components that can be executed within an RDC, such as RDC 340-1, may be: UPFs 350, SMFs 360, and AMFs 370. While instances of UPFs 350 and SMFs 360 may be executed in local zones 320, SMFs 360 may be executed across multiple local zones 320 for redundancy, processing load-balancing, and fail-over.

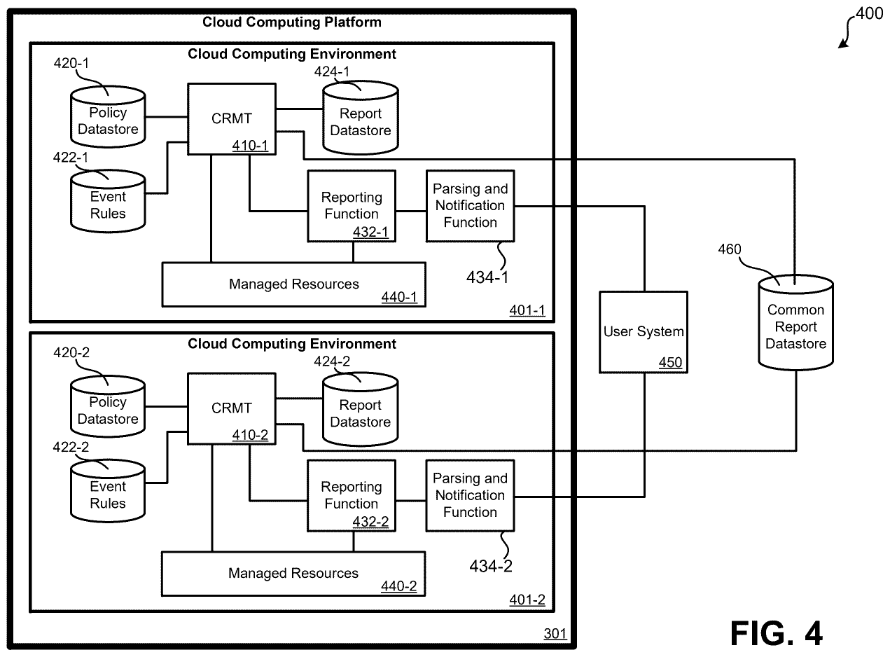

The cellular network system arrangements of FIGS. 1-3 represent a high-level block diagram of various components. When cellular network components, such as core NFs, are implemented on cloud computing infrastructure (e.g., public cloud computing infrastructure), significant monitoring and management needs to be performed on the instances of cloud-implemented components. FIG. 4 illustrates an embodiment of a cloud resource monitoring and management system 400 (“system 400”). System 400 can include: cloud resource management tools (CRMTs) 410, policy datastores 420, event rules 422, report datastores 424, function creators 430, reporting functions 432, parsing and notification functions 434, managed resources 440, user system 450, and common report data store 460.

As previously detailed, cloud computing platform 301 can represent a public cloud computing platform on which an entity, such as a cellular network service provider, maintains multiple cloud computing environments 410. Each of the cloud computing environments 401 may be linked with separate credentials and accounts. As such, components in cloud computing environment 401-1 may, at least as a default, be isolated on the public cloud computing platform from components of cloud computing environment 401-2.

CRMTs 410 allow for cloud resources to be managed by performing filtering and applying actions to such resources. Various types of cloud-based managed resources 440 can be monitored and managed. In the context of a cellular network, cellular NFs can be managed resources 440, which can be monitored and managed using CRMTs 410. As an example, referencing monitoring capabilities, reports on instances of cellular NFs meeting certain search criteria may be created using CRMTs 410. As another example, referencing management capabilities, based on certain search criteria, various cellular NFs can be tagged for deletion, such as based on the creation date of such cellular NFs.

CRMTs 410 can be a third-party resource configured to be loaded onto and executed in the cloud within one or more cloud computing environments 401. As an example, CRMTs 410 can be instances of Cloud Custodian. In other embodiments, other forms of CRMTs 410 can be used. CRMTs 410 can either reside directly within a cloud computing environment or use provided credentials to access a cloud computing environment.

Referring to cloud computing environment 401-1, CRMT 410 is in communication with policy datastore 420-1 and event rules 422-1. Policy datastore 420-1 defines one or more polices. Each policy can define one or more filtering terms and actions to be taken on managed resources 440-1. Each policy may be written in YAML, in some other data serialization language, or in some other machine-readable programming language.

Event rules 422-1 define when policies from policy datastore 420-1 are executed. Event rules 422-1 can define some form of chronological schedule for each policy of the one or more policies present in policy datastore 420-1. Different policies can be executed on different schedules. For example, some policies may be run once daily at a defined time, while other policies may be executed weekly.

Based on an event rule from event rules 422-1, CRMT 410-1 executes a particular policy from policy datastore 420-1. As a cellular network specific example, filtering conditions may be used to identify cellular NFs from managed resources 440-1 of a particular type that are more than a defined period of time in age. For each identified cellular NF, a log entry may be made, and the cellular NF may be tagged for deletion in a defined number of days. A separate policy, for example, may then be used to delete the cellular NF after the defined number of days has elapsed.

Based on the filtering and actions taken by CRMT 410-1, one or more entries can be generated that are recorded to report datastore 424-1 and/or common report datastore 460. Report datastore 424-1 may be particular to CRMT 410-1 within cloud computing environment 401-1 while common report datastore 460 is accessed and written to by multiple CRMTs 410 across multiple cloud computing environments. For example, as illustrated, two cloud computing environments 401 (e.g., a production environment and a non-production environment) are present on cloud computing platform 301, each of which writes log entries based on the policies executed by their respective CRMT to common report datastore 460. Common report datastore 460 can exist on a separate computing system (e.g., a computing system maintained by the cellular network provider) or in another cloud computing environment on cloud computing platform 301. In other embodiments, many more cloud computing environments can operate according to the general arrangement detailed in relation to FIG. 4.

CRMTs 410 may also be able to deploy functions within cloud computing environments 401. The functions invoked may be in the form of serverless functions, which are self-contained pieces of code that are involved in the cloud computing environment. In the context of AWS, this type of function can be referred to as a lambda function. CRMT 410-1 can deploy reporting function 432-1, which can monitor service activity within the cloud environment. For example, referring to AWS, reporting functions 432 can listen to CloudTrail events within cloud computing environments 401 and publish a corresponding event. Reporting function 432-1 can generally capture all activity within cloud computing environment 401-1, such as activity involving managed resources 440-1.

A separate function instantiated via CRMT 410-1 can allow for particular types of activities to be reported out to a user. A user, via user system 450, can subscribe to types of events which the user desires to be notified about. Based on the user subscribing to these types of events, when such an event is identified by parsing and notification function 434-1 in the captured activities output by reporting function 432-1, parsing and notification function 434-1 can parse out the needed information (which can involve inflating a compressed file, parsing out relevant information) and sending out a notification corresponding to the topic. This notification is sent to all users that are subscribed to the topic. Since reporting functions 432 and parsing and notification functions 434 are created by CRMTs 410 across multiple cloud computing environments, users, such as a user via user system 450, can receive notifications relevant to multiple cloud computing environments 401.

CRMT 410-1 can also be used to involve a function in another cloud computing environment (other than cloud computing environment 401-1). That is, based on a policy in policy datastore 420-1 and, possibly, according to a schedule defined in event rules 422-1, CRMT 410-1 can use previously provided account credentials to involve a function in another cloud computing environment. This function can be used to report back on and invoke resources identified in the other cloud computing environment.

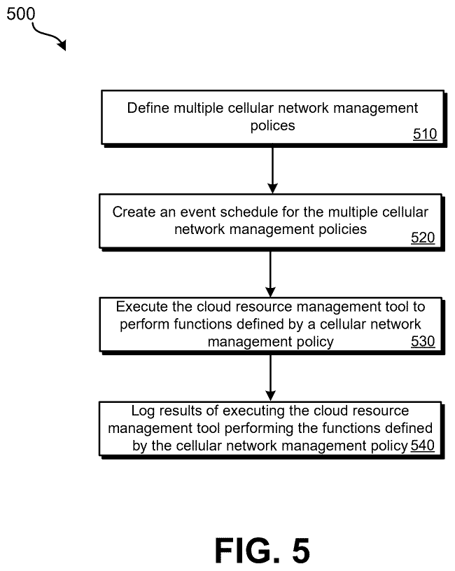

Using system 400, various methods can be performed. FIG. 5 illustrates an embodiment of a method 500 for performing cloud resource management. Method 500 can be performed using system 400 of a variation thereof. At block 510, multiple cellular network management (and/or monitoring) policies may be defined. These cellular network management policies can be stored to a policy datastore residing within the same cloud computing environment in which a cloud resource management tool has been instantiated. Each policy stored to a policy datastore may include filtering conditions and actions to be taken on cloud resources, such as cellular network functions, within the cloud computing environment, that meet the filtering conditions. The actions to be taken can include reporting actions (e.g., logging a status to a report datastore) and/or modifying a resource, such as by applying a tag to it (e.g., to mark for deletion), or performing another action (e.g., deleting).

At block 520, an event schedule for the multiple cellular network monitoring policies is created. The event schedule can be user-defined and can define a time-based schedule on which policies within policy datastores in the cloud computing environment are performed. At block 530, a cloud resource management tool can be executed within the cloud computing environment to perform actions defined within the cellular network monitoring policy according to the corresponding event schedule.

At block 540, the results of executing the cloud resource management tool can be logged, such as to multiple datastores. Logging can occur to a first report datastore maintained within the same cloud computing environment and to a second report datastore outside of the cloud computing environment. This second report datastore can be logged to by multiple cloud resource management tools existing in multiple cloud computing environments.

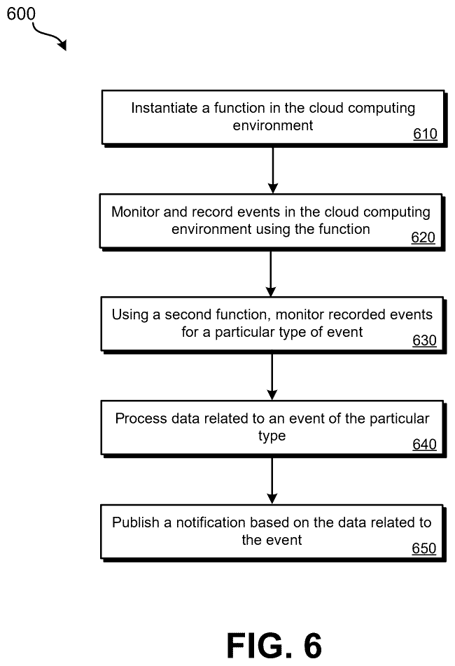

FIG. 6 illustrates another embodiment of a method 600 for performing cloud resource management. In method 600, at block 610, a CRMT can instantiate a function (e.g., a serverless function) in a cloud computing platform to listen to events being performed by cloud resources (e.g., cellular network functions). In an AWS environment, the function can listen to CloudTrail events.

At block 620, the function monitors and records events in the cloud computing environment. At block 630, a separate function can be used to monitor the recorded events for a specific type of event. For each of the specific type of event identified, the recorded event may be analyzed, data extracted, and a notification created at block 640 by the second function executed in the cloud computing environment. For each user account that has subscribed for the particular type of event, the notification can be transmitted to the user account (e.g., via email) at block 650.

Such notifications can be generated and transmitted from multiple cloud computing environments. Therefore, a user, via a user account, can subscribe to a particular type of event and will then be alerted to the event occurring, via a notification including information about the event, for multiple cloud computing environments.

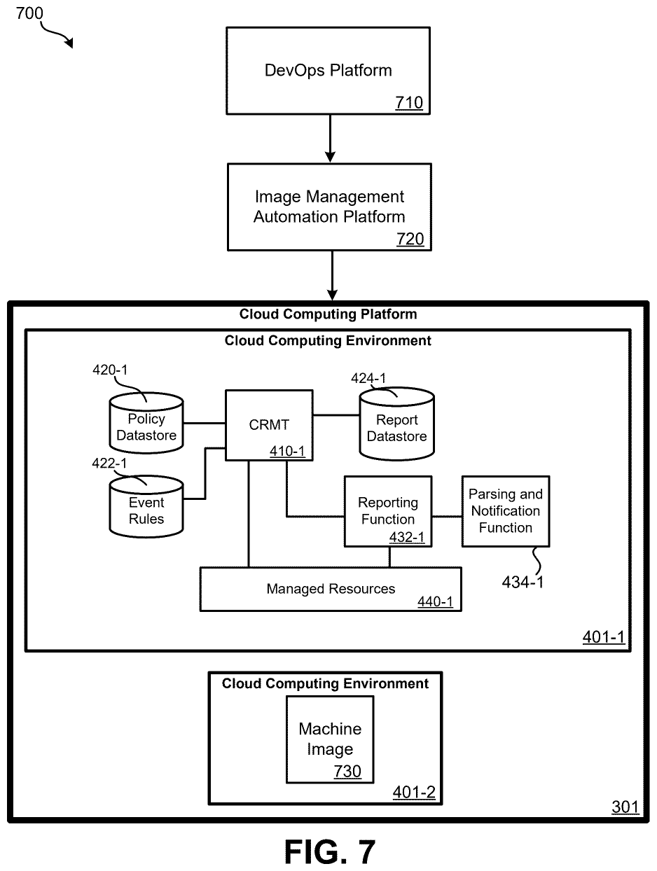

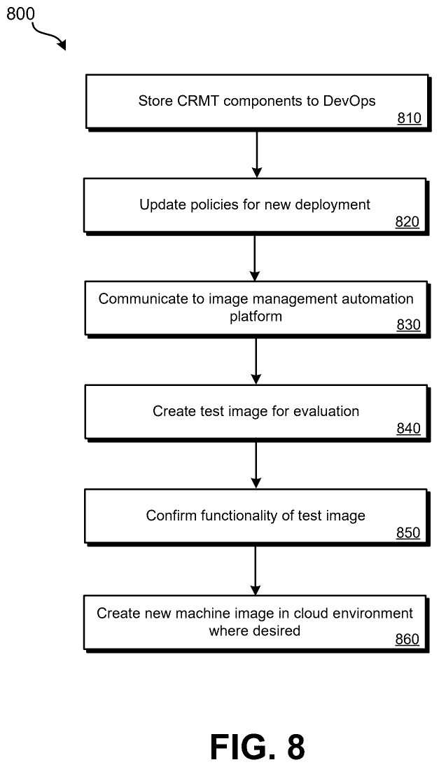

FIG. 7 illustrates an embodiment of a system 700 for deploying the cloud resource monitoring and management system to additional environments, and FIG. 8 illustrates an embodiment of a method 800 for deploying the cloud resource monitoring and management system to additional environments. System 700 can represent the arrangement of system 400 prior to deployment to cloud computing environment 401-2. That is, system 700 and method 800 can be used to deploy the arrangement of cloud computing environment 401-1 to cloud computing environment 401-2.

System 700 can include: DevOps (Development and Operations) platform 710; image management automation platform 720; cloud computing platform 301; cloud computing environments 401; and machine images 730. A DevOps platform allows for the creation, storage, management, and sharing of code. For example, GitHub is a possible embodiment of a DevOps platform. At block 810 of method 800, software code for a deployment of CRMT 410 is stored to the DevOps platform. This software code is capable of deploying the reporting function 432 and parsing and notification function 434, in addition to executing policies based on event rules.

At block 820, policies and events are created, modified, and/or updated for the cloud computing environment into which a CRMT is to be deployed. The code for the CRMT, along with the updated policies and event schedule, are transmitted to image management automation platform 720 at block 830. Image management automation platform can represent a separate platform from the DevOPs platform. In some embodiments, image management automation platform 720 can be implemented using Global Image Management Platform (GIMP) or some other similar form of platform. Image management automation platform 720 can be used for testing and evaluating a test image prior to deployment.

At block 830, on image management automation platform 720, a test image is created for evaluation. Prior to deployment, functionality of the test image is confirmed at block 850. The test image is modified as necessary for proper functionality. Once functionality has been confirmed, the tested image is deployed to the cloud computing environment, associated with another account, where the CRMT arrangement is to be deployed. As shown in FIG. 7, an image based on the arrangement deployed in cloud computing environment 401-1 is deployed to cloud computing environment 401-2 in the form of machine image 730. An instance is launched from machine image 730, which can include policy datastore 420, CRMT 410, and report datastore 424. Event rules 422, reporting function 432, and parsing and notification function 434 may not be included in machine image 730. The CRMT arrangement can then be used to monitor and manage cloud resources in cloud computing environment 401-2.

It should be noted that the methods, systems, and devices discussed above are intended merely to be examples. It must be stressed that various embodiments may omit, substitute, or add various procedures or components as appropriate. For instance, it should be appreciated that, in alternative embodiments, the methods may be performed in an order different from that described and that various steps may be added, omitted, or combined. Also, features described with respect to certain embodiments may be combined in various other embodiments. Different aspects and elements of the embodiments may be combined in a similar manner. Also, it should be emphasized that technology evolves and, thus, many of the elements are examples and should not be interpreted to limit the scope of the invention.

Specific details are given in the description to provide a thorough understanding of the embodiments. However, it will be understood by one of ordinary skill in the art that the embodiments may be practiced without these specific details. For example, well-known processes, structures, and techniques have been shown without unnecessary detail in order to avoid obscuring the embodiments. This description provides example embodiments only, and is not intended to limit the scope, applicability, or configuration of the invention. Rather, the preceding description of the embodiments will provide those skilled in the art with an enabling description for implementing embodiments of the invention. Various changes may be made in the function and arrangement of elements without departing from the scope of the claims.

Also, it is noted that the embodiments may be described as a process which is depicted as a flow diagram or block diagram. Although each may describe the operations as a sequential process, many of the operations can be performed in parallel or concurrently. In addition, the order of the operations may be rearranged. A process may have additional steps not included in the figure.

Having described several embodiments, it will be recognized by those of skill in the art that various modifications, alternative constructions, and equivalents may be used without departing from the scope of the claims. For example, the above elements may merely be a component of a larger system, wherein other rules may take precedence over or otherwise modify the application of the invention. Also, a number of steps may be undertaken before, during, or after the above elements are considered. Accordingly, the above description should not be taken as limiting the scope of the invention.

What is claimed is:

1. A method for performing cellular network cloud resource management, the method comprising:
defining, on a cloud computing platform, a plurality of cellular network monitoring policies within a storage container;
creating, on the cloud computing platform, an event schedule that defines an execution time for each cellular network monitoring policy to be executed on the cloud computing platform;
based on the event schedule, executing, on the cloud computing platform, a cloud resource management tool to perform a plurality of functions defined by a cellular network monitoring policy of the plurality of cellular network monitoring policies; and
logging, by the cloud resource management tool on the cloud computing platform, a plurality of results of executing the cloud resource management tool performing the plurality of functions defined by the cellular network monitoring policy.

2. The method for performing cellular network cloud resource management of claim 1, wherein executing the cloud resource management tool to perform the plurality of functions defined by the cellular network monitoring policy comprises:
filtering, by the cloud resource management tool, a plurality of instances of cellular network functions (NFs) executed on the cloud computing platform to identify one or more instances of cellular NFs that meet a set of parameters of the cellular network monitoring policy; and
performing, by the cloud resource management tool, an action on each of the one or more identified instances of cellular NFs that meet the set of parameters of the cellular network monitoring policy.

3. The method for performing cellular network cloud resource management of claim 2, wherein the one or more identified instances of cellular NFs are 5G New Radio (NR) core NFs.

4. The method for performing cellular network cloud resource management of claim 2, wherein the action comprises tagging the one or more identified instances of cellular NFs for deletion.

5. The method for performing cellular network cloud resource management of claim 1, further comprising:
accessing, by the cloud resource management tool, the cloud computing platform account credentials mapped to a cloud computing platform account, wherein the cloud computing platform is a public cloud computing platform.

6. The method for performing cellular network cloud resource management of claim 5, wherein the cloud resource management tool performs the plurality of functions defined by the cellular network monitoring policy of the plurality of cellular network monitoring policies within a cloud environment accessible via the cloud computing platform account.

7. The method for performing cellular network cloud resource management of claim 6, further comprising:
accessing, by the cloud resource management tool, a second set of cloud computing platform account credentials mapped to a second cloud computing platform account;
executing, on the cloud computing platform, the cloud resource management tool to perform the plurality of functions defined by the cellular network monitoring policy of the plurality of cellular network monitoring policies within a second cloud environment accessible via the second cloud computing platform account; and
logging, by the cloud resource management tool, a second plurality of results of executing the cloud resource management tool performing the plurality of functions defined by the cellular network monitoring policy to a report datastore.

8. The method for performing cellular network cloud resource management of claim 1, wherein executing the cloud resource management tool to perform the plurality of functions defined by the cellular network monitoring policy comprises:
deploying, by the cloud resource management tool, a function on the cloud computing platform wherein, the function monitors application programming interface (API) events.

9. The method for performing cellular network cloud resource management of claim 8, further comprising:
publishing, by the function on the cloud computing platform that monitors API events, event information based on a monitored API event; and
obtaining, by a second function executed on the cloud computing platform, the event information based on the second function having been subscribed to a type of event corresponding to the monitored API event.

10. The method for performing cellular network cloud resource management of claim 9, further comprising:
causing, by the second function executed on the cloud computing platform, a notification to be transmitted to one or more user accounts that are subscribed to the type of event, wherein the notification is based on the obtained event information.

11. A cloud resource monitoring and management system comprising:
a cloud computing environment defined on a cloud computing platform;
a plurality of cellular network monitoring policies within a storage container in the cloud computing environment;
an event schedule that defines an execution time for each cellular network monitoring policy to be executed in the cloud computing environment on the cloud computing platform; and
a cloud resource management tool within the cloud computing environment, wherein:
the cloud resource management tool is configured to perform a plurality of functions defined by a cellular network monitoring policy of the plurality of cellular network monitoring policies based on the event schedule; and
the cloud resource management tool is configured to log a plurality of results of executing the plurality of functions defined by the cellular network monitoring policy.

12. The cloud resource monitoring and management system of claim 11, wherein the cloud resource management tool is further configured to:
filter a plurality of instances of cellular network functions (NFs) executed on the cloud computing platform to identify one or more instances of cellular NFs that meet a set of parameters of the cellular network monitoring policy; and
perform an action on each of the one or more identified instances of cellular NFs that meet the set of parameters of the cellular network monitoring policy.

13. The cloud resource monitoring and management system of claim 12, wherein the one or more identified instances of cellular NFs are 5G New Radio (NR) core NFs.

14. The cloud resource monitoring and management system of claim 12, wherein the action comprises tagging the one or more identified instances of cellular NFs for deletion.

15. The cloud resource monitoring and management system of claim 11, wherein the cloud resource management tool is further configured to:
access the cloud computing platform account credentials mapped to a cloud computing platform account, wherein the cloud computing platform is a public cloud computing platform.

16. The cloud resource monitoring and management system of claim 11, wherein the cloud resource management tool is further configured to:
execute to perform the plurality of functions defined by the cellular network monitoring policy of the plurality of cellular network monitoring policies within a second cloud environment accessible via the second cloud computing platform account; and
log a second plurality of results of executing the cloud resource management tool to a report datastore.

17. The cloud resource monitoring and management system of claim 11, wherein the cloud resource management tool is further configured to:
deploy a function within the cloud computing environment on the cloud computing platform, wherein the function monitors application programming interface (API) events.

18. The cloud resource monitoring and management system of claim 17, wherein:
the function on the cloud computing platform that monitors API events is configured to publish event information based on a monitored API event; and
the cloud resource monitoring and management system further comprising a second function executed in the cloud computing environment on the cloud computing platform, wherein the second function is configured to obtain event information from the function for a type of event corresponding to the monitored API event.

19. The cloud resource monitoring and management system of claim 18, wherein the second function is further configured to:
cause a notification to be transmitted to one or more user accounts that are subscribed to the type of event, wherein the notification is based on the obtained event information.

20. A non-transitory processor-readable medium comprising processor-readable instructions configured to cause one or more processors to:
define a plurality of cellular network monitoring policies within a storage container in a cloud computing environment on a cloud computing platform;
create an event schedule that defines an execution time for each cellular network monitoring policy to be executed in the cloud computing environment on the cloud computing platform;
based on the event schedule, perform a plurality of functions defined by a cellular network monitoring policy of the plurality of cellular network monitoring policies in the cloud computing environment on the cloud computing platform; and
log a plurality of results of executing the plurality of functions defined by the cellular network monitoring policy within the cloud computing environment and external to the cloud computing environment.
